(19) United States
(12) Patent Application Publication
(10) Pub. No.: US 2016/0281309 A1
(43) Pub. Date: Sep. 29, 2016

(54) Site-Specific Spraying System

(71) Applicant: Caterpillar Inc., Peoria, IL (US)

(72) Inventors: Qi Wang, Pittsburgh, PA (US); Brad L. Holsapple, Metamora, IL (US); Qi Chen, Dunlap, IL (US)

(73) Assignee: Caterpillar Inc., Peoria, IL (US)

(21) Appl. No.: 14/670,699

(22) Filed: Mar. 27, 2015

(51) Int. Cl. E01H 3/02; B05B 12/12; G05D 7/06; E21F 5/02

(52) U.S. Cl. CPC E01H 3/02; E21F 5/02; B05B 12/12; G05D 7/0676

(57) ABSTRACT

System and methods for determining and controlling appropriate fluid delivery are disclosed. One method includes determining a first electrical conductivity value associated with soil at a first location of a worksite, determining a first global position associated with the first location, comparing the first electrical conductivity value to a first predetermined threshold associated with the first global position, and if the first electrical conductivity value is less than the first predetermined threshold, triggering a sprayer to spray the soil at the first location with fluid.

### TECHNICAL FIELD

This patent disclosure relates generally to fluid delivery and, more particularly, to methods and systems for efficiently delivering an appropriate quantity of fluid to a worksite.

### BACKGROUND

Work environments associated with a certain industries, such as the mining and construction industries, are often susceptible to undesirable dust conditions. For example, worksites associated with mining, excavation, constructions, landfills, and material stockpiles may be particularly susceptible to dust due to the nature of materials composing the worksite surface. For example, worksite surfaces of coal, shale, stone, etc., erode easily, and thus may tend to produce significant amounts of dust. Moreover, typical work operations performed at these sites may exacerbate the dust conditions. At a mine site, for example, cutting, digging, and scraping operations may break up the worksite surface, generating dust. In addition, heavy machinery, such as haul trucks, dozers, loaders, excavators, etc., traveling on such sites may disturb settled dust, thereby increasing the dust level of the air.

Undue dust conditions may reduce the efficiency of a worksite. For example, dust may impair visibility, interfere with work operations on the site, reduce machinery life, and require increased equipment maintenance and cleaning.

Water trucks may be used to spray water on worksites, and in particular, roads of worksites. Often, water is sprayed based on various environmental factors (e.g., soil type, temperature, general dustiness) that are observed by humans, such as an operator of a water truck for example. These observations can be inaccurate, and therefore locations of worksite may be insufficiently sprayed or excessively sprayed. Insufficient spraying may not reduce dust effectively, thereby creating problems such as those mentioned above. Excessive spraying may cause muddy road conditions, which can result in impaired travel, and therefore reduced productivity, or reduced machinery life, for example, among other problems.

U.S. Pat. No. 8,360,343 describes a mobile fluid delivery machine for delivering fluid to a site. The machine has a communication device configured to receive fluid delivery mission instructions from a worksite control facility. In particular, information gathered by a sensor system may be used by the worksite control facility and/or by fluid delivery machines to determine a fluid delivery route and/or an amount of fluid to deliver to the route, among other things. For example, the sensor system may include a temperature sensor configured to sense an atmospheric temperature of a worksite, a radiation sensor configured to sense an intensity of solar radiation at worksite, a pressure sensor configured to sense an atmospheric pressure at worksite, a humidity sensor configured to sense the humidity at worksite, a dust sensor configured to determine a dust condition or a dust level of the air at worksite, a wind sensor configured to sense a speed and/or direction of the wind on worksite, and a precipitation sensor configured to determine an amount or rate of precipitation on worksite. However, the above-described fluid delivery machine may not be informed of undue dust conditions until the undue dust conditions, and issues associated therewith, have already occurred.

Accordingly, there is a need for improved fluid delivery apparatus and methods to address the aforementioned issues or other problems in the art.

### SUMMARY

This patent disclosure relates to system and methods for delivering fluid, for example water, to locations in a worksite. In one aspect, a method may include determining a first electrical conductivity value associated with soil at a first location of a worksite, determining a first global position associated with the first location, comparing the first electrical conductivity value to a first predetermined threshold associated with the first global position, and if the first electrical conductivity value is less than the first predetermined threshold, triggering a sprayer to spray the soil at the first location with fluid.

In another aspect, a fluid control system may include a sensor configured to detect a first electrical conductivity value associated with soil at a first location of a worksite, a location device configured to determine a first global position associated with the first location, a controller communicatively coupled to the sensor and the location device, and a memory bearing instructions that, upon execution by the processor, cause the system at least to: compare the first electrical conductivity value to a first predetermined threshold associated with the first global position, and if the first electrical conductivity value is less than the first predetermined threshold, trigger a sprayer to spray the soil at the first location with fluid.

In yet another aspect, a fluid delivery machine may include a sensor configured to detect a first electrical conductivity value associated with soil at a first location of a worksite, a location device configured to determine a first global position associated with the first location, a sprayer configured to deliver fluid to the soil of the worksite, a controller communicatively coupled to the sensor and the location device, and a memory bearing instructions that, upon execution by the processor, cause the system at least to: compare the first electrical conductivity value to a first predetermined threshold associated with the first global position, and if the first electrical conductivity value is less than the first predetermined threshold, trigger a sprayer to spray the soil at the first location with fluid.

### BRIEF DESCRIPTION OF THE DRAWINGS

FIG. 1 is a schematic view of an exemplary worksite at which aspects of the disclosure may be employed.

FIG. 2A is a rear perspective view of a machine, according to an aspect of the disclosure.

FIG. 2B is front perspective view of the exemplary machine in FIG. 2A, according to an aspect of the disclosure.

FIG. 3 is a graphical representation of exemplary electrical conductivity values in accordance with aspects of this disclosure.

FIG. 4 is a flow chart of an exemplary method in accordance with aspects of the disclosure.

FIG. 5 is a block diagram of a computer system configured to implement the method of FIG. 4 in accordance with an aspect of this disclosure.

### DETAILED DESCRIPTION

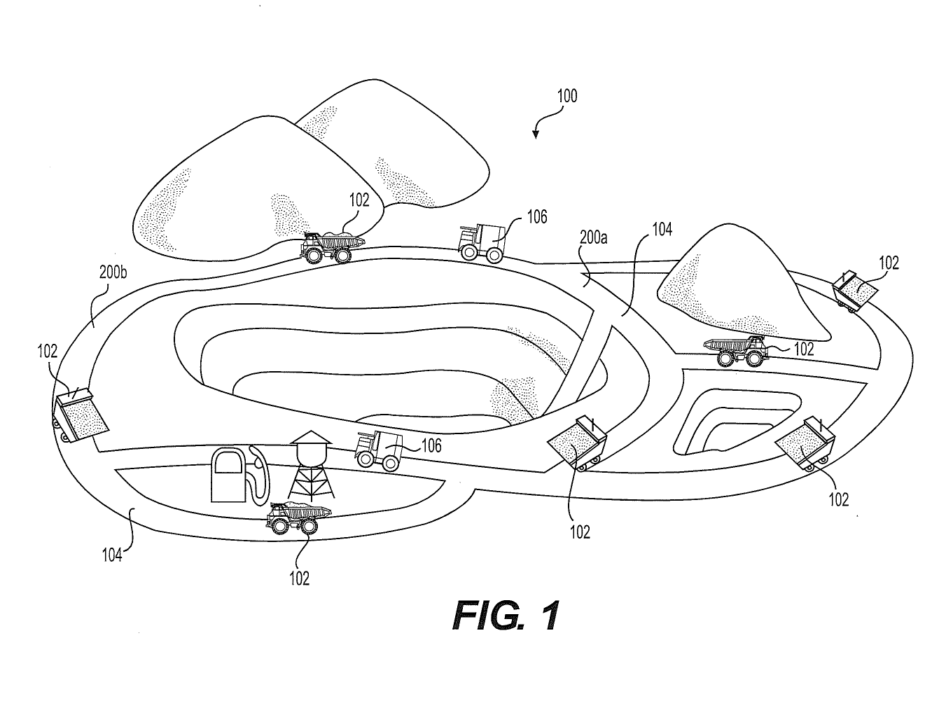

Referring to the drawings, wherein like reference numbers refer to like elements, FIG. 1 illustrates an exemplary worksite 100 at which aspects described herein may be employed. In one environment, the worksite 100 may embody a surface mine site where mining operations may generate dust. While some aspects are described herein with reference to the worksite 100, it will be appreciated that other aspects of the disclosure may implemented in any worksite, such as a construction site, a landfill, an underground mine site, or any other type of worksite at which dust may arise. The worksite 100 may benefit from spraying fluid, for instance water, on various surfaces to treat dust conditions or to prevent dust conditions from arising. In other exemplary aspects, the worksite 100 may alternatively or additionally require fluid delivery to compact the soil and prepare the worksite surface for cutting, digging, scraping, excavating, or other operations.

As shown in the FIG. 1, a variety of work machines 102 may operate at the worksite 100. The work machines 102 may include any combination of autonomous (e.g., unmanned) machines, semi-autonomous machines, and operator-controlled machines. Work machines 102 may include, for example, off-highway haul trucks, articulated trucks, excavators, loaders, dozers, scrapers, or other types of earth-working machines for excavating or handling material on the worksite 100. In connection with operations on the worksite 100, the work machines 102 may travel along roads 104, which may also be referred to as haul roads 104, of the worksite 100 or along other paths between excavation locations, dumping areas, and other destinations on the worksite 100. The work machines 102 may also perform cutting, digging, scraping, excavating, loading, or other operations at various locations on the worksite 100.

In addition, one or more fluid delivery machines 106 may perform fluid deliver operations at the worksite 100. For example, the fluid delivery machines 106 may be dispatched on roads 104 to deliver (e.g., spray) fluid on surfaces of the worksite 100 to control dust conditions. Alternatively or additionally, fluid delivery machines 106 may be dispatched to deliver fluid to the worksite 100 to condition surfaces for cuffing, digging, scraping, excavating, loading, or other operations.

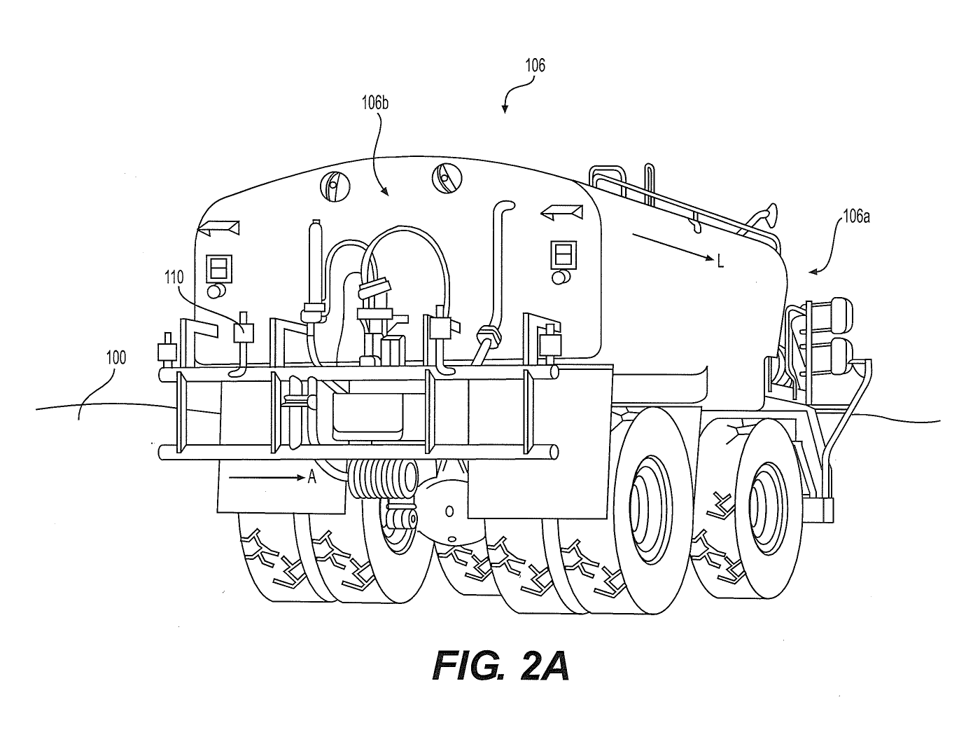

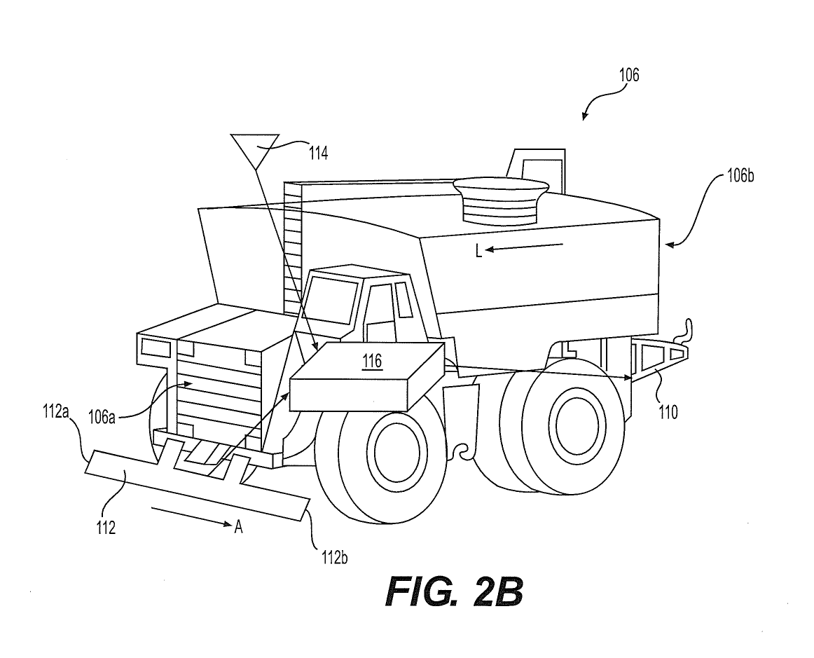

FIGS. 2A and 2B illustrate an exemplary fluid delivery machine 106. In an exemplary aspect, the fluid delivery machine 106 may be an off-highway truck converted for fluid delivery. As shown, the fluid delivery machine 106 may define a front end 106a and a rear end 106b opposite the front end 106a along a longitudinal direction L. The fluid delivery machine 106 a include a fluid tank 108 that is configured to store fluid, such as water, dust suppressant, or other fluids for mitigating dust or preparing the worksite 100 for certain operations. It will be understood that the fluid delivery machine 106 may include an assembly of piping, hoses, valves, and/or other hydraulic elements for pumping, pressurizing, carrying, and/or transporting fluid.

In accordance with the illustrated aspect, the fluid delivery machine 106 may include one or more spray heads 110 (which may also be referred to simply as sprayers 110) that are configured to spray the fluid stored in the tank 108. The spray heads 110 may spray fluid onto the surface of the worksite 100 while the fluid delivery machine 106 is traveling, for instance along the longitudinal direction L, or while the fluid delivery machine 106 is stationary. Thus, the sprayers 110 may be configured to deliver fluid to the soil of the worksite 100. In accordance with the illustrated aspect, the fluid delivery machine 106 may also include one or more soil sensors, such as a first sensor or soil sensor 112, which is further described below. As shown, the soil sensor 112 is mounted to the front end 106a of the fluid delivery machine 106, although it will be understood that the soil sensor 112 may be alternatively located on the fluid delivery machine 106 as desired. For example, the soil sensor 112 may be attached to the rear end 106b of the fluid delivery machine 106b. In an exemplary aspect, the sensor 112 is attached to one of the front and rear ends 106a-b and the sprayers 110 are attached to the other of the front and rear ends 106a-b.

While aspects are described herein with reference to the fluid delivery machine 106, it will be appreciated that any machine, vehicle, device or the like can use the soil sensor 112 and components associated therewith in accordance with aspects of the disclosure.

Referring in particular to FIG. 2B, the sensor 112 can be elongate in a lateral direction A that is substantially perpendicular to the longitudinal direction L. The sensor 112 can define a first end 112a and a second end 112b opposite the first end 112a along the lateral direction A. The first end 112a may be configured as a receiver and the second end 112b may be configured as a transmitter. Alternatively, the first end 112a may be configured as a transmitter and the second end 112b may be configured as a receiver. Thus, the first end 112a may be configured as one of a receiver or a transmitter and the second end 112b may be configured as the other one of a receiver or a transmitter.

In an exemplary aspect, the soil sensor 112 can be configured as a noncontact electrical conductivity sensor. Thus, the soil sensor 112 can be mounted or otherwise carried by the fluid delivery machine 106 such that the soil sensor 112 does not touch the surface of the worksite 100, which can be referred to generally as soil. In operation, the sensors 122 can detect electrical conductivity values associated with soil. For example, the transmitter of the sensor 112 may direct an electric field into the soil, which in turn may drive an electric current through the soil. The receiver of the sensor 112 receives an electromagnetic field induced by the current through the soil. The strength of the resulting electromagnetic field may be proportional to the electrical conductivity of the soil, or otherwise correlate with the electrical conductivity of the soil.

For example, in response to electric fields having the same magnitude, a first soil that is less conductive than a second soil will generate an electromagnetic field that is less strong than an electromagnetic field generated in the second soil. Thus, a measurement of the electromagnetic field from the first soil compared to a measurement of the electromagnetic field from the second soil, in response to electric fields having the same magnitude, would indicate that the first soil has have an electrical conductivity that is lower than an electrical conductivity of the second soil. It is recognized herein that the electrical conductivity of the soil may be indicative of a water content associated with the soil. Thus, based on the measurements described in the example above, the water content of the first soil may be less than the water content of the second soil.

Referring particularly to FIG. 2B, the fluid delivery machine 106 may include a location device 114 that may be configured to determine a global position of the fluid delivery machine 106 at the worksite 100. The location device 114 may include, for example, a Global Positioning System (GPS) device, a Global Navigation Satellite System (GNSS) device, a laser range finder device, an Inertial Reference Unit (IRU), or an odometric or dead-reckoning positioning device. In an exemplary aspect, the location device 114 provides latitude and longitude coordinates of a location associated with the fluid delivery machine 106.

FIG. 2B also illustrates various aspects of an exemplary fluid control system configured to perform various methods disclosed herein. The present disclosure is relevant to systems and methods for delivering fluid, for example. It will be appreciated that present methods may be used in various types of networks and systems that employ both digital and analog equipment. The system is described as including elements. An element may be software, hardware, or a combination of software and hardware. It will be appreciated that provided herein is a functional description and that the respective functions may be performed by software, hardware, or a combination of software and hardware.

The system may include a controller 116 (e.g., physical computer host, virtual machine, IP-capable device) in communication with the sensor 112 and the location device 114. The controller 116 may also be communicatively connected to the sprayers 110. As shown, the controller 116 may be disposed locally on (onboard) the fluid delivery machine 106. Alternatively, the controller 116 may be disposed remotely relative to the fluid delivery machine 106. As an example, the controller 116 may be in communication with the sensor 112, the location device 114, and the sprayers 110 via wired or wireless communication channels. As described herein, the controller 116 may trigger one or more of the sprayers 110 to spray fluid onto soil. The controller 116 may also control the sprayers 110 such that no fluid is sprayed on the soil. In an exemplary configuration, a sprayer 110 may be spraying fluid, and the controller 116 may terminate the spraying, for instance, by closing a valve supplying a nozzle of the sprayer 110, such that no fluid is sprayed on the soil.

The controller 116 may include any type of computer or a plurality of computers networked together. It is also contemplated that computers at different locations may be networked together to form the controller 116, if desired. The controller 28 may include among other things, a console, an input device, an input/output device, a storage media, and a communication interface. The console may be any appropriate type of computer display device that provides a graphical user interface (GUI) to display results and information to operators and other users at the worksite 100, for instance operators of the fluid delivery machine 106. The input device may be provided for operators to input information into the controller 116. For example, operators may input predetermined thresholds of electrical conductivity, as described in detail below. The input device may include, for example, a keyboard, a mouse, or another computer input device. The input/output device may be any type of device configured to read/write information from/to a portable recording medium. The input/output device may include among other things, a floppy disk, a CD, a DVD, a flash memory read/write device or the like. The input/output device may be provided to transfer data into and out of the controller 116 using a portable recording medium. The storage media may include any means to store data within the controller 116, such as a hard disk. The storage media may be used to store a database containing among others, predetermined thresholds, electrical conductivity maps, and previously measured electrical conductivity values. The communication interface may contain network connections, data link connections, and/or antennas configured to receive wireless data. Data may be transferred to the controller 116 electronically or manually. Electronic transfer of data may include the remote transfer of data using the wireless capabilities or the data link of the communication interface by a communication channel.

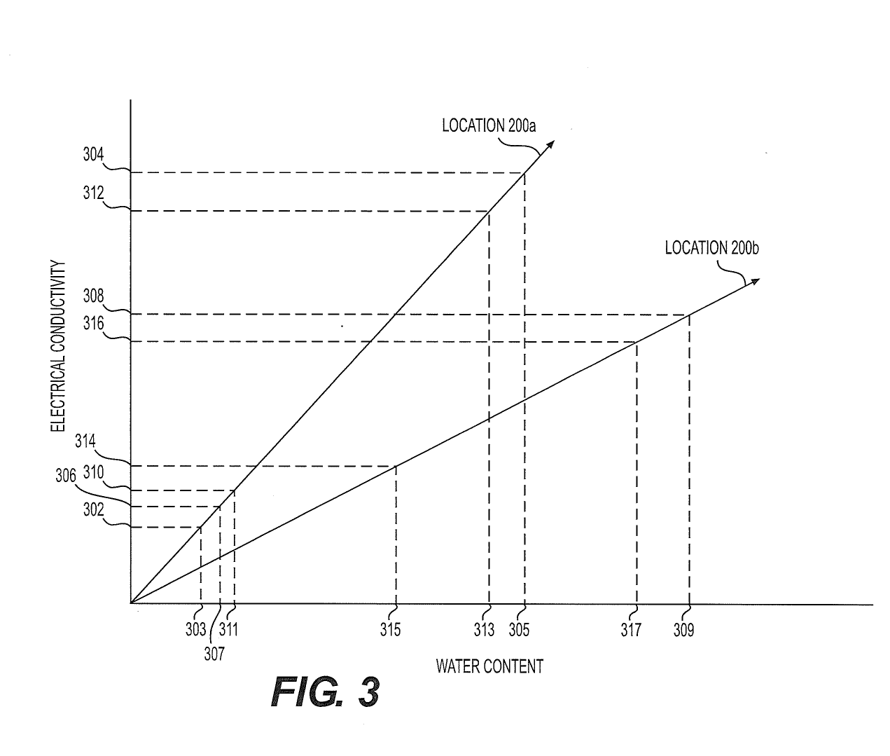

In an exemplary configuration, referring to the illustrative example shown in FIG. 3, the sensor 112 can detect a dry electrical conductivity value, (e.g., a dry electrical conductivity value 302) that is associated with soil at a location (e.g., a first location 200a) of the worksite 100 that is in a dry condition. The dry electrical conductivity value 302 can be detected when the soil has not been sprayed, and thus is in a dry condition. The sensor 112 can detect a wet electrical conductivity value (e.g., a wet electrical conductivity value 304) that is associated with soil at a location (e.g., the first location 200a) of the worksite 100 that is in a wet condition. The wet electrical conductivity value 304 can be detected after the soil has been sprayed, such that the soil is in a wet condition. The dry electrical conductivity value 302 may be indicative of a dry water content value 303 associated with the soil at the first location 200a, and the wet electrical conductivity value 304 may be indicative of a wet water content value 305 associated with the soil at the first location 200a. For example, as shown in FIG. 3, electrical conductivity values may be a function of water content. Furthermore, as also shown in FIG. 3, the function may be substantially linear such that the wet electrical conductivity value 304 at the first location 200a and its corresponding water content value 305 define a linear relationship relative to the dry electrical conductivity value 302 at the first location 200a and its corresponding water content value 303.

In another exemplary configuration, the sensor 112 can detect a dry electrical conductivity value 306 that is associated with soil at a second location 200b of the worksite 100 that is in a dry condition. The dry electrical conductivity value 306 can be detected when the soil has not been sprayed, and thus is in a dry condition. The sensor 112 can detect a wet electrical conductivity value 308 that is associated with soil at the second location 200b of the worksite 100 that is in a wet condition. The wet electrical conductivity value 308 can be detected after the soil has been sprayed, such that the soil is in a wet condition. The dry electrical conductivity value 306 may be indicative of a dry water content value 307 associated with the soil at the second location 200b, and the wet electrical conductivity value 308 may be indicative of a wet water content value 309 associated with the soil at the second location 200b. For example, electrical conductivity values may be a function of water content.

Furthermore, as shown in FIG. 3, the function may be substantially linear such that the wet electrical conductivity value 308 at the second location 200b and its corresponding water content value 309 define a linear relationship relative to the dry electrical conductivity value 306 at the second location 200b and its corresponding water content value 307. However, as shown in the illustrative example of FIG. 3, the linear relationship defined at the first location 200a may be different than the linear relationship defined at the second location 200b. Thus, although the wet electrical conductivity values are linearly related to their respective dry electrical conductivity values, the linear relationships may differ as compared to each other, for example, based on the properties of the soil at the first and second locations 200a and 200b, respectively.

It will be understood that the sensor 112 can detect wet electrical conductivity values and dry electrical conductivity values for any location, for instance all locations, at the worksite 100. In an aspect, the location device 114 determines a global position associated with each location. Thus, each wet electrical conductivity value and each dry electrical conductivity value may be associated with a global position. The controller 116 can use the wet electrical conductivity values and the dry electrical conductivity values to calibrate the system. For example, the controller 116 can select one or more threshold electrical conductivity values that are associated with a given global position, and the threshold electrical conductivity values (hereinafter referred to generally as predetermined thresholds) may be greater than the dry electrical conductivity value associated with the given global position and less than the wet electrical conductivity value associated with the given global position. Alternatively, or additionally, the predetermined thresholds may be selected by an operator. The predetermined thresholds may be indicative of respective water content values associated with respective locations. Thus, the predetermined thresholds may be used to determine whether a given location should be sprayed with fluid.

In an exemplary aspect, after thresholds have been determined using the wet and dry electrical conductivity values, the fluid delivery machine 106 may travel on the roads 104 of the worksite 100. With continuing reference to FIG. 3, while the fluid delivery machine 106 travels, the sensor 112 may detect an electrical conductivity value, for instance a first electrical conductivity value, associated with soil at the first location 200a of the worksite 100. The location device 114 may determine a global position, for instance a first global position, associated with the first location 200a.

In an exemplary aspect, a predetermined threshold, for instance a first or lower predetermined threshold 310, is associated with the first global position. The first predetermined threshold 310 may be indicative of a first water content value 311 associated with the soil at the first location 200a. Such predetermined thresholds may be stored in memory accessible by the controller 116. The controller 116 may compare the first electrical conductivity value to the first predetermined threshold 310 associated with the first global position. In an exemplary configuration, if the first electrical conductivity value is less than the first predetermined threshold 310, the controller 116 triggers the sprayers 110 to spray the soil at the first location 200a with fluid. For example, the controller 116 may control the sprayers 110 to spray the soil at the first location 200a until the electrical conductivity value associated with the first location 200a is greater than the first predetermined threshold 310. In another exemplary configuration, if the first electrical conductivity value is greater than the first predetermined threshold 310, the controller 116 may control the sprayers 110 such that no fluid is sprayed on the soil at the first location 200a.

In yet another exemplary aspect, a second or upper predetermined threshold 312 may be associated with the first global position. The second predetermined threshold 312 may be greater than the first predetermined threshold 310. Thus, the second predetermined threshold 312 may be indicative of a second water content value 313 associated with the soil at the first location 200a that is greater than the first water content value 311. In an exemplary configuration, for instance if the worksite 100 is generally in a dry condition, the fluid delivery machine 106 may travel on the roads of the worksite 100 with nozzles of the sprayers 110 in an open position, such that fluid is delivered to the soil of the worksite 100. As the fluid delivery machine 106 travels, the sensor 112 may detect the first electrical conductivity value associated with soil at the first location 200a of the worksite 100. The controller 116 may compare the first electrical conductivity value to the second predetermined threshold 312 associated with the first global position. If the first electrical conductivity value is greater than the second predetermined threshold 312, the controller 116 may close a nozzle of the sprayers 110 such that no fluid is sprayed on the soil of the first location 200a.

It will be understood that the exemplary aspects described above may be implemented at any location of the worksite 100 or any other worksite. For example, as shown, the sensor 112 may detect an electrical conductivity value, for instance a third electrical conductivity value, associated with soil at the second location 200b of the worksite 100. The location device 114 may determine a global position, for instance a second global position, associated with the second location 200b. In an exemplary aspect, predetermined thresholds, for instance a third or lower predetermined 314 and a fourth or upper predetermined threshold 316, are associated with the second global position. The third predetermined threshold 314 may be indicative of a water content value, for instance a third water content value 315, associated with the soil at the second location 200b. The fourth predetermined threshold 316 may be indicative of a water content value, for instance a fourth water content value 317, associated with the soil at the second location 200b. The fourth water content value 317 may be greater than the third water content value 315. The controller 116 may compare the second electrical conductivity value to the third predetermined threshold 314 associated with the second global position.

In an exemplary configuration, if the second electrical conductivity value is less than the third predetermined threshold 314, the controller 116 triggers the sprayers 110 to spray the soil at the second location 200b with fluid. For example, the controller 116 may control the sprayers 110 to spray the soil at the second location 200b until the electrical conductivity value associated with the second location 200b is greater than the third predetermined threshold 314. In another exemplary configuration, if the second electrical conductivity value is greater than the third predetermined threshold 314, the controller 116 may control the sprayers 110 such that no fluid is sprayed on the soil at the second location 200b. In yet another example configuration in which the fluid delivery machine 106 travels on the roads 104 of the worksite 100 while spraying, the controller 116 may compare the second electrical conductivity value to the fourth predetermined threshold 316 associated with the second global position as the fluid delivery machine travels. If the second electrical conductivity value greater than the fourth predetermined threshold 316, the controller 116 may close a nozzle of the sprayers 110 such that no fluid is sprayed on the soil of the second location 200b.

As described above, and as shown in FIG. 3, it will be understood that the first predetermined threshold 310 at the first location 200a and its corresponding water content value 311 may define a first linear relationship relative to the second predetermined threshold 312 at the first location 200a and its corresponding water content value 313. Furthermore, the third predetermined threshold 314 at the second location 200b and its corresponding water content value 315 may define a second linear relationship relative to the fourth predetermined threshold 316 at the second location 200b and its corresponding water context value 317. The first linear relationship may be substantially the same as the linear relationship defined by the dry electrical conductivity value 302 at the first location 200a and its corresponding water content value 303 relative to the wet electrical conductivity value 304 at the first location 200b and its corresponding water content value 305. The second linear relationship may be different than the first linear relationship, for instance if the soil at the second location 200b differs from the soil at the first location 200a. Furthermore, as shown, the predetermined thresholds may be between their respective dry and wet electrical conductivity values. In other words, in accordance with an exemplary aspect, a predetermined threshold at a given location is greater than the dry electrical conductivity value at the given location and less than the wet electrical conductivity value at the given location.

### INDUSTRIAL APPLICABILITY

The present disclosure is applicable to systems on work machines, and more specifically to fluid control systems on fluid delivery machines. Various worksites may benefit from spraying a fluid, for instance water, on various surfaces to treat dust conditions or to prevent dust conditions from arising. Worksites may alternatively or additionally require fluid delivery to compact the soil and prepare the worksite 100 surface for cutting, digging, scraping, excavating, or other operations. Referring to FIG. 1, as an illustrative example, fluid delivery machines 106 may perform fluid deliver operations at the worksite 100. For example, the fluid delivery machines 106 may be dispatched on roads 104 to deliver (e.g., spray) fluid on surfaces of the worksite 100 to control dust conditions. Alternatively or additionally, fluid delivery machines 106 may be dispatched to deliver fluid to the worksite 100 to condition surfaces for cutting, digging, scraping, excavating, loading, or other operations. Using the methods and systems described above, it can be determined, for instance in real-time as the fluid delivery machine 106 travels on the roads 104, whether a given location should be sprayed. Such determinations can be made by the controller 116, thus eliminating operator discretion, which can result in locations being oversprayed or undersprayed.

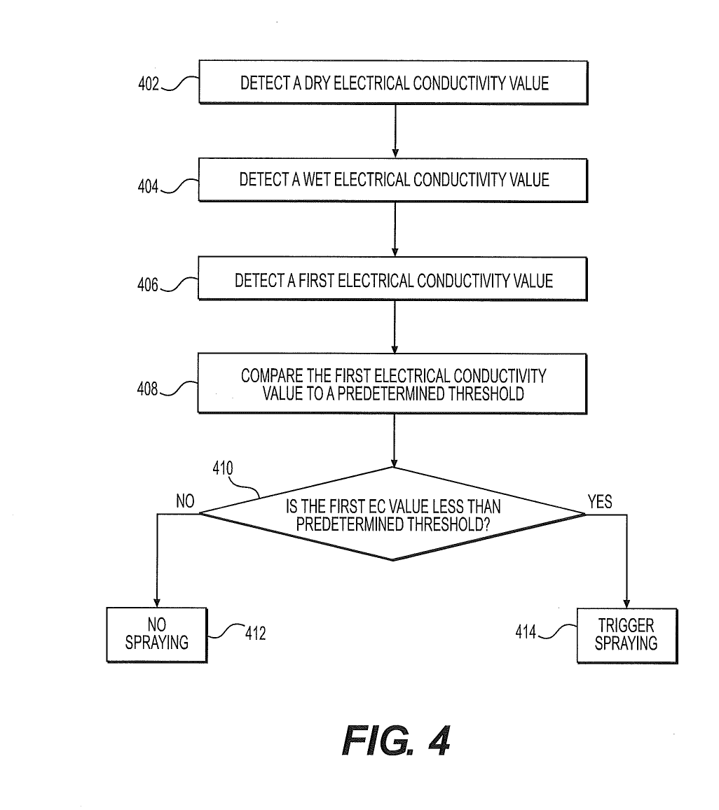

FIG. 4 is a flow diagram that illustrates a method that may be performed by the machine depicted in FIGS. 2B and 2C in accordance with an exemplary aspect of this disclosure. Referring to FIG. 4, at 402, the sensor 112 may detect dry electrical conductivity values that are associated with soil at respective locations of the worksite 100 that is in a dry condition. Dry electrical conductivity values can be detected when the soil has not been sprayed, and thus is in a dry condition. At 404, the sensor 112 can detect wet electrical conductivity values that are associated with soil at respective locations of the worksite 100 that is in a wet condition. The wet electrical conductivity values can be detected after the soil has been sprayed, such that the soil is in a wet condition. As described above, the controller 116 can select one or more threshold electrical conductivity values that are associated with a given global position, and the threshold electrical conductivity values, referred to as predetermined thresholds, may be greater than the dry electrical conductivity value associated with the given global position and less than the wet electrical conductivity value associated with the given global position. Alternatively, or additionally, the predetermined thresholds may be selected by an operator. The predetermined thresholds may be indicative of respective water content values associated with respective locations. Thus, the predetermined thresholds may be used to determine whether a given location should be sprayed with fluid.

In operation, as shown at 406, the fluid delivery machine, and in particular the sensor 112, may detect electrical conductivity values, for example as the fluid delivery machine 106 travels on the roads 104 of the worksite 100. For example, the fluid delivery machine 106 may detect an electrical conductivity value associated with soil at a first location of the worksite 100. Using the location device 114, for example, a first global position associated with the first location may be determined.

At 408, the controller 116 may compare the first electrical conductivity value to a first predetermined threshold that is associated with the first global position. At 410, the controller 116 may determine whether the first electrical conductivity value is less than the predetermined threshold. In accordance with the illustrated example, if the first electrical conductivity value is less than the first predetermined threshold, the process proceeds to 414, where the controller 116 triggers one or more sprayers 110 to spray the soil at the first location with fluid. If the first electrical conductivity value is greater than the first predetermined threshold, the process proceeds to 412, where the controller 116 controls the sprayers 110 such that no fluid is sprayed on the soil. It will be understood, as described above, that a predetermined threshold may be selected such that spraying occurs if a given electrical conductivity value is less than or equal to the predetermined threshold. It will be further understood that a predetermined threshold may be selected such that spraying is stopped if an electrical conductivity value is greater than or equal to the predetermined threshold.

It will be appreciated that the various illustrative logical blocks, modules, and method steps described in connection with the aspects disclosed herein may be implemented as electronic hardware, computer software, or combinations of both. To clearly illustrate this interchangeability of hardware and software, various illustrative components, blocks, modules, and steps have been described above generally in terms of their functionality.

Whether such functionality is implemented as hardware or software depends upon the design constraints imposed on the overall system. Persons having skill in the art may implement the described functionality in varying ways for each particular application, but such implementation decisions should not be interpreted as causing a departure from the scope of the disclosure. In addition, the grouping of functions within a module, block, or step is for ease of description. Specific functions or steps may be moved from one module or block without departing from the disclosure.

The various illustrative logical blocks and modules described in connection with the aspects disclosed herein may be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor (e.g., of a computer), or in a combination of the two. A software module may reside, for example, in RAM memory, flash memory, ROM memory, EPROM memory, EEPROM memory, registers, hard disk, a removable disk, a CD-ROM, or any other form of storage medium. An exemplary storage medium may be coupled to the processor such that the processor may read information from, and write information to, the storage medium. In the alternative, the storage medium may be integral to the processor. The processor and the storage medium may reside in an ASIC.

In at least some aspects, a processing system (e.g., controller 116) that implements a portion or all of one or more of the technologies described herein may include a general-purpose computer system that includes or is configured to access one or more computer-accessible media.

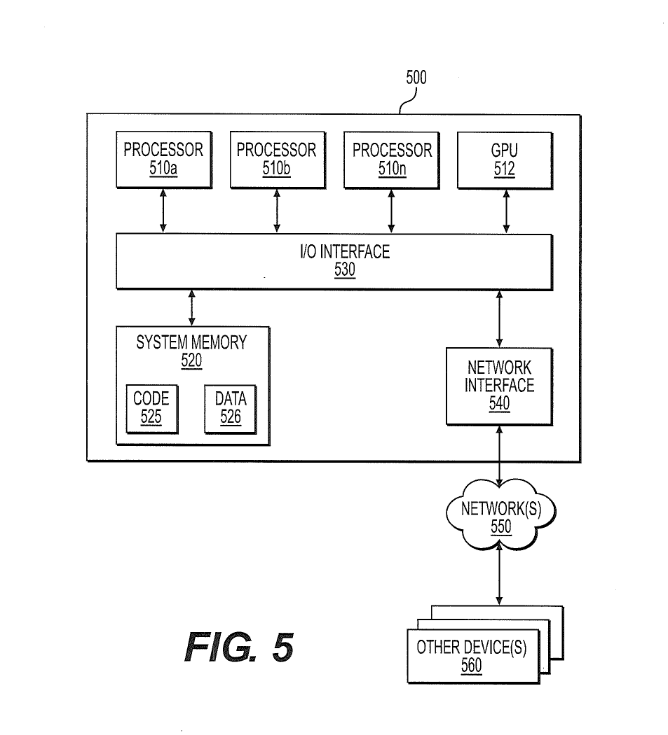

FIG. 5 depicts a general-purpose computer system that includes or is configured to access one or more computer-accessible media. In the illustrated aspect, a computing device 500 includes one or more processors 510a, 510b, and/or 510n (which may be referred herein singularly as a processor 510 or in the plural as the processors 510) coupled to a system memory 520 via an input/output (I/O) interface 530. Computing device 500 further includes a network interface 540 coupled to the I/O interface 530.

In various aspects, computing device 500 may be a uniprocessor system including one processor 510 or a multiprocessor system including several processors 510 (e.g., two, four, eight, or another suitable number). Processors 510 may be any suitable processors capable of executing instructions. For example, in various aspects, the processor(s) 510 may be a general-purpose or embedded processors implementing any of a variety of instruction set architectures (ISAs), such as the x86, PowerPC, SPARC, or MIPS ISAs, or any other suitable ISA. In multiprocessor systems, each of the processors 510 may commonly, but not necessarily, implement the same ISA.

In some aspects, a graphics processing unit (“GPU”) 512 may participate in providing graphics rendering and/or physics processing capabilities. A GPU may, for example, include a highly parallelized processor architecture specialized for graphical computations. In some aspects, the processors 510 and the GPU 512 may be implemented as one or more of the same type of device.

System memory 520 may be configured to store instructions and data accessible by the processor(s) 510. In various aspects, the system memory 520 may be implemented using any suitable memory technology, such as static random access memory (“SRAM”), synchronous dynamic RAM (“SDRAM”), nonvolatile/Flash®-type memory, or any other type of memory. In the illustrated aspect, program instructions and data implementing one or more desired functions, such as those methods, techniques and data described above, are shown stored within system the memory 520 as code 525 and data 526.

In one aspect, the I/O interface 530 may be configured to coordinate I/O traffic between the processor(s) 510, the system memory 520 and any peripherals in the device, including the network interface 540 or other peripheral interfaces. In some aspects, the I/O interface 530 may perform any necessary protocol, timing or other data transformations to convert data signals from one component (e.g., system memory 520) into a format suitable for use by another component (e.g., processor 510). In some aspects, the I/O interface 530 may include support for devices attached through various types of peripheral buses, such as a variant of the Peripheral Component Interconnect (PCI) bus standard or the Universal Serial Bus (USB) standard, for example. In some aspects, the function of the I/O interface 530 may be split into two or more separate components, such as a north bridge and a south bridge, for example. Also, in some aspects some or all of the functionality of the I/O interface 530, such as an interface to the system memory 520, may be incorporated directly into the processor 510.

Network interface 540 may be configured to allow data to be exchanged between the computing device 500 and other device or the devices 560 attached to a network or networks 550, such as other computer systems or devices, for example. In various aspects, the network interface 540 may support communication via any suitable wired or wireless general data networks, such as types of Ethernet networks, for example. Additionally, the network interface 540 may support communication via telecommunications/telephony networks on a communication channel is defined herein, such as analog voice networks or digital fiber communications networks, via storage area networks, such as Fibre Channel SANs (storage area networks), or via any other suitable type of network and/or protocol.

In some aspects, the system memory 520 may be one aspect of a computer-accessible medium configured to store program instructions and data as described above for implementing aspects of the corresponding methods and apparatus. However, in other aspects, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to the computing device 500 via the I/O interface 530. A non-transitory computer-accessible storage medium may also include any volatile or non-volatile media, such as RAM (e.g., SDRAM, DDR SDRAM, RDRAM, SRAM, etc.), ROM, etc., that may be included in some aspects of the computing device 500 as the system memory 520 or another type of memory. Further, a computer-accessible medium may include transmission media or signals, such as electrical, electromagnetic or digital signals, conveyed via a communication medium, such as a network, a communication channel is defined herein, and/or a wireless link, such as those that may be implemented via network interface 540. Portions or all of the multiple computing devices, such as those illustrated in FIG. 5, may be used to implement the described functionality in various aspects; for example, software components running on a variety of different devices and servers may collaborate to provide the functionality. In some aspects, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

It should also be appreciated that the systems in the figures are merely illustrative and that other implementations might be used. Additionally, it should be appreciated that the functionality disclosed herein might be implemented in software, hardware, or a combination of software and hardware. Other implementations should be apparent to those skilled in the art. It should also be appreciated that a server, gateway, or other computing node may include any combination of hardware or software that may interact and perform the described types of functionality, including without limitation desktop or other computers, database servers, network storage devices and other network devices, PDAs, tablets, cellphones, wireless phones, pagers, electronic organizers, Internet appliances, television-based systems (e.g., using set top boxes and/or personal/digital video recorders), and various other consumer products that include appropriate communication capabilities. In addition, the functionality provided by the illustrated modules may in some aspects be combined in fewer modules or distributed in additional modules. Similarly, in some aspects the functionality of some of the illustrated modules may not be provided and/or other additional functionality may be available.

Each of the operations, processes, methods, and algorithms described in the preceding sections may be embodied in, and fully or partially automated by, code modules executed by at least one computer or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example aspects. The example systems and components described herein may be configured differently than described. For example, elements may be added to, removed from, or rearranged compared to the disclosed example aspects.

It will also be appreciated that various items are illustrated as being stored in memory or on storage while being used, and that these items or portions of thereof may be transferred between memory and other storage devices for purposes of memory management and data integrity. Alternatively, in other aspects some or all of the software modules and/or systems may execute in memory on another device and communicate with the illustrated computing systems via inter-computer communication. Furthermore, in some aspects, some or all of the systems and/or modules may be implemented or provided in other ways, such as at least partially in firmware and/or hardware, including, but not limited to, at least one application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other aspects. Accordingly, the present disclosure may be practiced with other computer system configurations.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of aspects disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of aspects disclosed herein. The accompanying claims and their equivalents are intended to cover such forms or modifications as would fall within the scope and spirit of certain aspects disclosed herein.

The preceding detailed description is merely exemplary in nature and is not intended to limit the disclosure or the application and uses of the disclosure. The described aspects are not limited to use in conjunction with a particular type of machine. Hence, although the present disclosure, for convenience of explanation, depicts and describes particular machine, it will be appreciated that the assembly and electronic system in accordance with this disclosure may be implemented in various other configurations and may be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

The disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), W-CDMA (Wideband Code-Division Multiple Access), Wireless Fidelity (Wi-Fi), Bluetooth, and/or the like, and/or a combination of two or more thereof.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

We claim:

1. A computer-implemented method comprising:
detecting a first electrical conductivity value associated with soil at a first location of a worksite;
determining a first global position associated with the first location;
comparing the first electrical conductivity value to a first predetermined threshold associated with the first global position; and
if the first electrical conductivity value is less than the first predetermined threshold, triggering a sprayer to spray the soil at the first location with a fluid.

2. The computer-implemented method of claim 1, the method further comprising:
if the first electrical conductivity value is greater than the first predetermined threshold, controlling the sprayer such that no fluid is sprayed on the soil at the first location.

3. The computer-implemented method of claim 1, the method further comprising:
comparing the first electrical conductivity value to a second predetermined threshold associated with the first global position, the second predetermined threshold being greater than the first predetermined threshold, wherein the first predetermined threshold is indicative of a first water content value associated with the soil at the first location, and the second predetermined threshold is indicative of a second water content value associated with the soil at the first location that is greater than the first water content value;
if the first electrical conductivity value is greater than the second predetermined threshold, closing a nozzle of the sprayer such that no fluid is sprayed on the soil at the first location.

4. The computer-implemented method of claim 3, the method further comprising:
detecting a second electrical conductivity value associated with soil at a second location of the worksite;
determining a second global position associated with the second location;
comparing the second electrical conductivity value to a third predetermined threshold associated with the second global position; and
if the second electrical conductivity value is less than the third predetermined threshold, triggering the sprayer to spray the soil at the second location with a fluid.

5. The computer-implemented method of claim 4, the method further comprising:
comparing the second electrical conductivity value to a fourth predetermined threshold associated with the second global position, the fourth predetermined threshold being greater than the third predetermined threshold, wherein the third predetermined threshold is indicative of a third water content value associated with the soil at the second location, and the fourth predetermined threshold is indicative of a fourth water content value associated with the soil at the second location that is greater than the third water content value;
if the second electrical conductivity value is greater than the fourth predetermined threshold, closing a nozzle of the sprayer such no fluid is sprayed on the soil at the second location.

6. The computer-implemented method of claim 5, wherein the first predetermined threshold and the second predetermined threshold define a first linear relationship with respect to each other, and the third predetermined threshold and the fourth predetermined threshold define a second linear relationship with respect to each other that is different from the first linear relationship.

7. The computer-implemented method of claim 3, the method further comprising:
detecting a dry electrical conductivity value associated with soil at the first location of the worksite when the soil is in a dry condition; and
detecting a wet electrical conductivity value associated with soil at the first location of the worksite when the soil is in a wet condition,
wherein the first predetermined threshold is between the wet electrical conductivity value and the dry electrical conductivity value.

8. The computer-implemented method of claim 7, wherein the wet electrical conductivity value and the dry electrical conductivity value define a linear relationship with respect to each other that is substantially the same as a linear relationship defined by the first and second predetermined thresholds with respect to each other.

9. A fluid control system comprising:
a sensor configured to detect a first electrical conductivity value associated with soil at a first location of a worksite;
a location device configured to determine a first global position associated with the first location;
a controller communicatively coupled to the sensor and the location device;
a memory bearing instructions that, upon execution by the controller, cause the system at least to:
compare the first electrical conductivity value to a first predetermined threshold associated with the first global position; and
if the first electrical conductivity value is less than the first predetermined threshold, trigger a sprayer to spray the soil with a fluid.

10. The fluid control system of claim 9, wherein the memory bears further instructions that cause the system to:
if the first electrical conductivity value is greater than the first predetermined threshold, control the sprayer such that no fluid is sprayed on the soil.

11. The fluid control system of claim 9, wherein the memory bears further instructions that cause the system to:
compare the first electrical conductivity value to a second predetermined threshold associated with the first global position, the second predetermined threshold being greater than the first predetermined threshold, wherein the first predetermined threshold is indicative of a first water content value associated with the soil at the first location, and the second predetermined threshold is indicative of a second water content value associated with the soil at the first location that is greater than the first water content value; and
if the first electrical conductivity value is greater than the second predetermined threshold, close a nozzle of the sprayer such no fluid is sprayed on the soil at the first location.

12. The fluid control system of claim 11, wherein:
the sensor is further configured to detect a second electrical conductivity value associated with soil at a second location of the worksite;
the location device is further configured to determining a second global position associated with the second location; and
the memory bears further instructions that cause the system to:
compare the second electrical conductivity value to a third predetermined threshold associated with the second global position; and
if the second electrical conductivity value is less than the third predetermined threshold, trigger the sprayer to spray the soil at the second location with fluid.

13. The fluid control system of claim 12, wherein the memory bears further instructions that cause the system to:
compare the second electrical conductivity value to a fourth predetermined threshold associated with the second global position, the fourth predetermined threshold being greater than the third predetermined threshold, wherein the third predetermined threshold is indicative of a third water content value associated with the soil at the second location, and the fourth predetermined threshold is indicative of a fourth water content value associated with the soil at the second location that is greater than the third water content value; and
if the second electrical conductivity value is greater than the fourth predetermined threshold, close a nozzle of the sprayer such no fluid is sprayed on the soil at the second location.

14. The fluid control system of claim 13, wherein the first predetermined threshold and the second predetermined threshold define a first linear relationship with respect to each other, and the third predetermined threshold and the fourth predetermined threshold define a second linear relationship with respect to each other that is different than the first linear relationship.

15. The fluid control system of claim 11, wherein the sensor is further configured to:
detect a dry electrical conductivity value associated with soil at the first location of the worksite when the soil is in a dry condition; and
detect a wet electrical conductivity value associated with soil at the first location of the worksite when the soil is in a wet condition,
wherein the first predetermined threshold is between the wet electrical conductivity value and the dry electrical conductivity value.

16. The fluid control system of claim 15, wherein the wet electrical conductivity value and the dry electrical conductivity value define a linear relationship with respect to each other that is substantially the same as a linear relationship defined by the first and second predetermined thresholds with respect to each other.

17. A fluid delivery machine defining a front end and a rear end opposite the front end, the fluid delivery machine comprising:
a sensor configured to detect a first electrical conductivity value associated with soil at a first location of a worksite as the fluid delivery machine travels along a road of the worksite;
a location device configured to determine a first global position associated with the first location;
a controller communicatively coupled to the sensor and the location device;
a sprayer configured to deliver a fluid to the soil of the worksite;
a memory bearing instructions that, upon execution by the controller, cause the fluid delivery machine at least to:
compare the first electrical conductivity value to a first predetermined threshold associated with the first global position; and
if the first electrical conductivity value is less than the first predetermined threshold, trigger the sprayer to spray the soil with the fluid.

18. The fluid delivery machine of claim 17, wherein the memory bears further instructions that cause the fluid delivery machine to:
if the first electrical conductivity value is greater than the first predetermined threshold, control the sprayer such that no fluid is sprayed on the soil.

19. The fluid delivery machine of claim 17, wherein the sensor is attached to one of the front end and the rear end of the fluid delivery machine, and the sprayer is attached to the other one of the front end and the rear end.

20. The fluid delivery machine of claim 19, wherein the sensor is attached to the front end, and the sprayer is attached to the rear end.
